(19) United States
(12) Patent Application Publication
(10) Pub. No.: US 2025/0316879 A1
(43) Pub. Date: Oct. 9, 2025

(54) HIGH TEMPERATURE RF SURFACE APERTURE SYSTEM

(71) Applicant: HRL LABORATORIES, LLC, Malibu, CA (US)

(72) Inventors: Ryan QUARFOTH, Malibu, CA (US); Christopher ROPER, Malibu, CA (US); Jacob HUNDLEY, Malibu, CA (US)

(21) Appl. No.: 19/206,036

(22) Filed: May 12, 2025

Related U.S. Application Data
(63) Continuation-in-part of application No. 17/887,697, filed on Aug. 15, 2022, now Pat. No. 12,344,406.
(60) Provisional application No. 63/234,031, filed on Aug. 17, 2021.

(51) Int. Cl. H01P 5/16

(52) U.S. Cl. CPC H01P 5/16

(57) ABSTRACT

A radio frequency surface-aperture, including: a mechanical support structure configured for maintaining mechanical stiffness and strength at a selected temperature; thermal insulation having at least a single layer; one or more through-thickness waveguides located through a thickness of the mechanical support structure and thermal insulation; a cold-side mode coupler arranged to connect a designated cold side of the one or more through-thickness waveguides to an electronic subsystem device; and one or more surface-wave waveguides arranged as an RF antenna on a surface of the mechanical support structure in operative communication with the through-thickness waveguides.

### CROSS-REFERENCE TO RELATED APPLICATION(S)

This patent application is a continuation-in-part of U.S. Patent Application No. 17/887,697, filed Aug. 15, 2022, which claims the benefit of and priority to U.S. Provisional Patent Application No. 63/234,031, filed on Aug. 17, 2021, the entire contents of both of which are incorporated herein by reference.

### FIELD

Embodiments of the present disclosure relate to a radio frequency surface-aperture system and a method of manufacturing a radio frequency surface-aperture system.

### BACKGROUND

Known high heat flux radio frequency (RF) aperture systems use a low-loss RF window to thermally insulate an Active Electronically Scanned Array (AESA) from a high heat flux, high temperature environment. However, this approach is infeasible at higher temperature environments such as those above 1200° C., because there are no aperture configurations and/or materials that possess the desired features of: (1) low RF loss, (2) ability to withstand high temperature, and (3) ability to withstand the aero-mechanical loads of hypersonic flight.

Known methods are limited to operating at temperatures below 1200° C. For example, a known state of the art method uses a transparent RF window which thermally insulates the AESA from a hot exterior of a vehicle. These thermal windows have the three noted features of: (1) low RF loss, (2) ability to withstand high temperature, and (3) ability to withstand the mechanical load of the hypersonic air flow. Materials are known which have all three features for temperatures up to 1200° C. However, there are no known materials that have these characteristics up to 2000° C. and beyond.

Mechanical integration (attachment, sealing) of an RF window into a thermal protection system (TPS) is a significant challenge in current vehicles. Additionally, lower temperature-capable window materials have different erosion or ablation characteristics than the TPS, leading to increased aerothermal heating due to surface discontinuities, subsequently increasing thermo-mechanical loads and probability of failure. For example, a document by E. A Kuhlman, High Temperature Antennas for Space Shuttle, NASA Contractor Report CR-2294 (1973), describes such a known high temperature RF aperture design, the disclosure of which document is hereby incorporated by reference herein in its entirety.

Known state of art systems use a transparent RF window configuration as a RF transparent thermal barrier to protect an AESA. However, this configuration is infeasible at temperatures near or above approximately 1200° C. because known RF window materials do not have (1) low RF loss, (2) the ability to withstand high temperature, and (3) the ability to withstand a mechanical load of hypersonic air flow.

The above information disclosed in this Background section is intended to enhance understanding of the background of the disclosure and may contain information that does not constitute prior art.

### SUMMARY

One or more embodiments of the present disclosure provide a radio frequency surface-aperture system including: a mechanical support structure for maintaining mechanical stiffness and strength at a selected temperature; thermal insulation having at least a single layer; one or more through-thickness waveguides located through a thickness of the mechanical support structure and thermal insulation; a cold-side mode coupler arranged to connect a designated cold side of the one or more through-thickness waveguides to an electronic subsystem; and one or more surface-wave waveguides arranged as a radio frequency (RF) antenna on a surface of the mechanical support structure in operative communication with the through-thickness waveguides.

One or more embodiments of the present disclosure provide a method of manufacturing a radio frequency surface-aperture system including: providing (supplying) a mechanical support structure for maintaining mechanical stiffness and strength at a selected temperature up to or greater than 1200° C.; applying a thermal insulation having at least a single layer to the mechanical support structure; establishing one or more through-thickness waveguides through a thickness of the mechanical support structure and the thermal insulation; arranging a cold-side mode coupler in operative contact with the mechanical support structure and thermal insulation to connect a designated cold side of the one or more through-thickness waveguides to an electronic subsystem; and providing (applying) one or more surface-wave waveguides arranged as an RF antenna on a surface of the mechanical support structure in operative communication with the through-thickness waveguides.

### BRIEF DESCRIPTION OF THE DRAWINGS

Other features and advantages of the present disclosure will become more apparent upon reading the following detailed description in conjunction with the accompanying drawings, wherein:

FIG. 1 is an isometric view of a radio frequency surface-aperture system, according to one or more embodiments of the present disclosure;

FIG. 2 is a cross-sectional view taken along the line I-I′ of FIG. 1, according to one or more embodiments of the present disclosure;

FIG. 3 is a cross-sectional view of the radio frequency surface-aperture system including a reflective wall, according to one or more embodiments of the present disclosure;

FIG. 4 is a cross-sectional view of a radio frequency surface-aperture system including a termination, according to one or more embodiments of the present disclosure.

### DETAILED DESCRIPTION

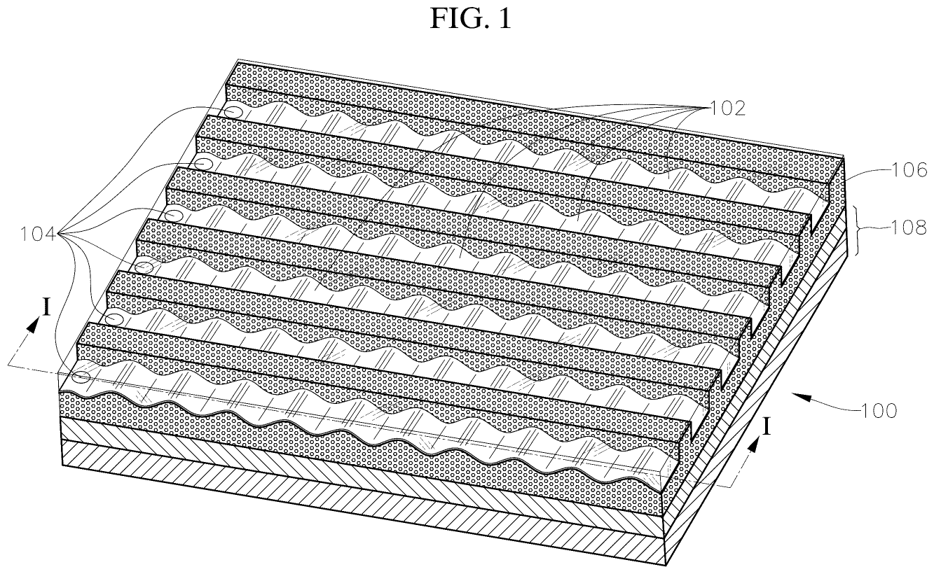

A radio frequency (RF) aperture system according to embodiments as disclosed in FIG. 1 uses a novel architecture to enable higher temperatures over a much broader temperature range, including temperatures that can extend over a range from very low temperatures to well above 1200° C.

Embodiments of the present disclosure encompass radio frequency surface-aperture systems, such as the aforementioned Active Electronically-Scanned Array (AESA) that can operate in high heat flux (>10 W/cm²) and/or high temperature (>1200° C.) environments under mechanical loading.

Referring to FIG. 1, an example of the architecture of a radio frequency surface-aperture system 100 as disclosed herein includes a mechanical support structure 106 made from a high-temperature, mechanically-robust material located on thermal insulation layers 108. The mechanical support structure 106 can be considered to have poor RF performance relative to other materials/layers of the aperture system 100. The mechanical support structure 106 may be in the form of a plane or layer.

An array of surface-wave waveguides 102 can be formed on a surface of the mechanically robust material of the mechanical support structure 106 using patterned high temperature capable thin films to function as a steerable RF antenna. A small number of through-thickness waveguides 104 can penetrate the mechanically robust material of the mechanical support structure 106 to connect the surface-wave waveguides 102 to a radar or seeker system (see, e.g., the electronic subsystem 204 described in more detail below) that is thermally insulated from a high temperature external environment. While FIG. 1 shows the aperture system 100 including six surface-wave waveguides 102 and through-thickness waveguides 104, the present disclosure is not limited thereto and the number of surface-wave waveguides 102 and through-thickness waveguides 104 may be varied as desired and/or as is suitable to the specific application.

The aperture system 100 can be configured using constituent materials that each may only achieve two of three specified features of among: (1) low RF loss; (2) an ability to withstand high temperature; and (3) an ability to withstand aero mechanical loads of hypersonic flight, but as disclosed herein, in combination, the constituent materials may achieve all three features. Mechanical robustness may be, for example, provided by outer material which primarily fills the aperture system 100, and low loss can be achieved by waveguides where RF power will be concentrated.

As described herein, embodiments of the present disclosure can allow for AESA operation from below 1200° C. to well above 1200° C. (e.g., including temperatures up to and including 1200° C.). High temperature operation can be desired and/or critical for hypersonic vehicles where extremely high heat fluxes lead to high external surface temperatures. It is desirable to have RF payloads that can transmit and receive in such an environment while maintaining low (<100° C.) operating temperatures for radar or seeker electronics.

A radio frequency surface-aperture system 100, as disclosed herein, thus includes a mechanical support plane or structure 106 configured for maintaining mechanical stiffness and strength at a selected temperature; thermal insulation layer(s) 108 having at least a single layer; and one or more through-thickness waveguides 104 located through the thicknesses of the mechanical support structure 106 and thermal insulation 108.

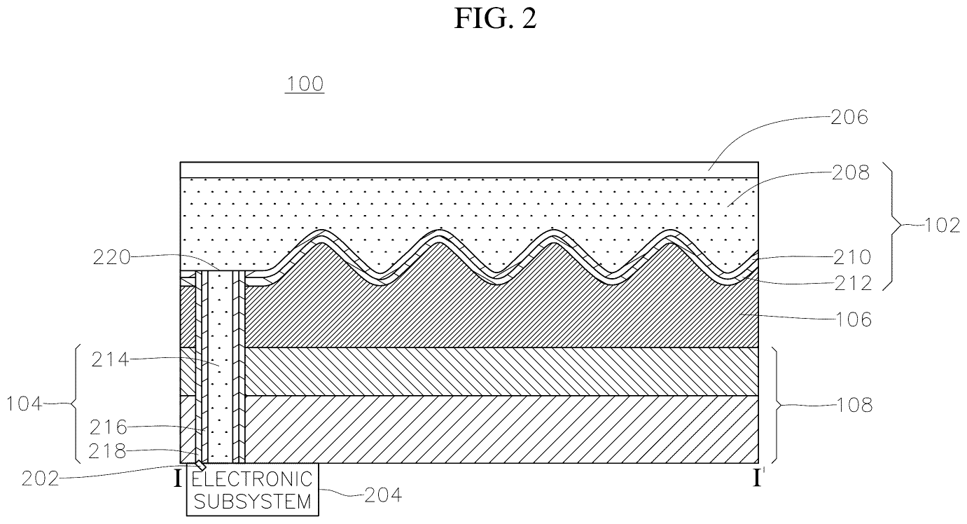

Referring to FIG. 2, which is a side view of FIG. 1, according to one or more embodiments, a cold-side mode-coupler 202 is arranged to connect a designated cold side of the one or more through-thickness waveguides 104 (e.g., the side at the bottom of FIG. 2 adjacent to the thermal insulation layers 108) to an electronic subsystem 204, such as a radar or seeker device, that can be optionally mounted on or within a vehicle (e.g., aircraft, unmanned aerial vehicle (UAV), missile or any airborne device). As shown in FIG. 2, the through-thickness waveguides 104 are configured with a dielectric core 214, an electrically conductive layer 216, and a diffusion barrier 218.

One or more of the surface-wave waveguides 102 on a surface of the mechanical support structure 106 are thereby in operative communication with the through-thickness waveguides 104 and the electronic subsystem 204. An optional high emissivity coating 206 can be provided on the surface-wave waveguides 102 as shown in FIG. 2, along with a dielectric layer 208, an electrically conductive layer 210, and a diffusion barrier 212 of the surface-wave waveguides 102.

Embodiments of the present disclosure also relate to a method of applying and/or using an aperture system as disclosed herein on any of a variety of vehicles (e.g., air vehicles, but also land and/or sea vehicles), in conjunction with any known or to be developed electronic subsystem, including but not limited to a seeker, or radar, or other device which is arranged to receive RF energy via the aperture system.

A method of manufacturing a radio frequency surface-aperture system 100, as disclosed herein includes: providing (supplying) a mechanical support structure 106 selected for maintaining mechanical stiffness and strength at a selected temperature equal to or greater than 1200° C.; applying a thermal insulation 108 having at least a single layer to the mechanical support structure 106; establishing one or more through-thickness waveguides 104 through a thickness of the mechanical support structure 106 and the thermal insulation 108; arranging a cold-side mode coupler 202 in operative contact with the mechanical support structure 106 and thermal insulation 108 to connect a designated cold side of the one or more through-thickness waveguides 104 to a radar or seeker device or other electronic subsystem 204; and providing (applying) one or more surface-wave waveguides 102 on a surface of the mechanical support structure 106 in operative communication with the through-thickness waveguides 104.

The disclosed method does not require use of a transparent RF window. Instead, the aperture system 100 can be positioned on top of an RF-opaque mechanical support structure 106 that can have desired (e.g., enhanced) thermal and mechanical properties, but which can possess poor RF performance (e.g., high RF loss or high RF conductivity which could make the aperture window reflective).

A small number of high temperature capable, low RF loss through-thickness RF waveguides 104 can enable RF transmission to an aerosurface of a vehicle such as a suppression aircraft. The number of these through-thickness waveguides 104 included in a system can be kept relatively small (e.g., less than or about 20, e.g., less than or about 10, or any appropriate number) to limit thermal conduction through the through-thickness waveguides 104. These through-thickness waveguides 104 can penetrate several inches into the vehicle and allow low-loss wave propagation from the hot exterior to the cool interior. On the cool interior, the through-thickness waveguides 104 can be combined with a traditional feed network to create an AESA.

In one or more embodiments, the through-thickness waveguides 104 can be a relatively small portion of the aperture system, such that the overall mechanical properties of the aperture system will effectively be similar to that of the mechanical support structure 106. RF energy transmitted through the through-thickness waveguides 104 can be coupled to the surface-wave waveguides 102, which enables RF transmit and receive functionality into/from surrounding air (or water). The result is an aperture system that can possess three desired components of a high temperature AESA: (1) low RF loss through the waveguides (i.e., through both the surface-wave and through-thickness waveguides 102 and 104); (2) an ability to withstand high temperatures of exposure with regard to the waveguides 102, 104 and mechanical support structure 106; and (3) strong mechanical properties as provided by the mechanical support structure 106.

Embodiments can be configured in numerous arrangements readily apparent to those skilled in the art, including but not limited to, embodiments which include additional surface-wave waveguides 102 and/or reduce the number of through thickness waveguides 104. Such embodiments can reduce the amount of heat conducted through the aperture system via the through-thickness waveguides 104, permitting longer use at high temperatures.

As already mentioned, embodiments of the high temperature radio frequency surface-aperture system as disclosed herein include: a mechanical support structure 106 configured for maintaining mechanical stiffness and strength at a selected temperature. The mechanical support structure 106 can be at least one of, for example, a flat plate, a singly-curved plate, or a doubly curved plate. The mechanical support structure 106 can be at least one of RF-lossy and/or RF-opaque. The mechanical support structure 106 can be configured and selected for operation so as to be capable of withstanding high temperatures (e.g., >1000° C., >1400° C. or greater) while maintaining a specified degree of mechanical stiffness and strength at select temperatures so as to provide a specified and/or intended support function.

The mechanical support structure 106 can, for example, be formed of a metal (e.g., Inconel, Haynes, Ni superalloy, a refractory metal (e.g., tungsten (W), molybdenum (Mo), tantalum (Ta), and/or niobium (Nb)) and/or a refractory metal alloy (e.g., TZM (titanium-zirconium-molybdenum) alloy, C103 alloy, and/or W—Re (tungsten-rhenium) alloy). The mechanical support structure 106 can, for example, alternately be a ceramic matrix composite such as those including carbon (C) or silicon(S) (e.g., C-to-C, or C/C or C/SiC), and/or a metal matrix composite.

The mechanical support structure 106 can include a designated hot side and a designated cold side where the hot side is arranged for exposure to temperatures which exceed those of the cold side. For example, the material of the mechanical support structure 106 can, for example, match (or is itself) the aeroshell or skin of a vehicle, such as an aerospace vehicle. Such features can reduce and/or minimize thermal stresses due to coefficient of thermal expansion mismatches.

As already mentioned, the radio frequency surface-aperture system 100 of FIG. 1 can include a thermal insulation layer 108 having at least a single layer. The thermal insulation layer 108 can be a single uniform layer or can be multiple layers, or any suitable combination thereof having a single or multiple materials to form the layers. For example, one or more layers of the thermal insulation 108 can be porous graphite (e.g., CalCarb); porous alumina, aluminosilicate, silica, and/or other oxide insulation (e.g., Zircar SALI, min-K); and/or porous nitride (e.g., boron nitride (BN)).

The insulation layer 108 of embodiments of the present disclosure has a hot side and a cold side, where the hot side is arranged for exposure to temperatures which will exceed those of the cold side. The cold side can, for example, be at e.g., about 0° C., about 25° C., about 50° C., about 100° C., about 200° C., or any other environment which can be used to select the configuration of the thermal insulation layer 108. The hot side of the insulation layer 108 can be arranged in contact with the cold side of the mechanical support structure 106.

In accordance with one or more embodiments, the thermal insulation layer(s) 108 is configured with materials and layers to withstand high temperatures of a specified environment or based on the applications in which the aperture system will be used. The thickness of each layer of thermal insulation 108 can be tailored such that each layer does not exceed is maximum use temperature, while minimizing overall insulation thickness and/or mass.

The radio frequency surface aperture system 100 according to the one or more embodiments already discussed can include one or more through-thickness waveguides 104 located through a thickness of the mechanical support structure 106 and thermal insulation layer(s) 108. Each of the one or more through-thickness waveguides 104 can penetrate the mechanical support structure 106 and the thermal insulation layer(s) 108, thus providing a low-loss RF path from the designated hot side of the mechanical support structure 106 to a designated cold side of the thermal insulation layer(s) 108. Each through-thickness waveguide 104 can have a designated hot side, near the hot side of the mechanical support structure 106 and a designated cold side, near the designated cold side of the thermal insulation layer(s) 108.

In one or more embodiments, the number of through thickness waveguides 104 of FIG. 1 can be minimized to minimize or reduce the heat conducted through the RF aperture system.

Each through-thickness waveguide 104 can include a core 214, an electrically conductive layer 216, and a diffusion barrier 218 (the electrically conductive layer 216 and the diffusion barrier 218 are collectively referred to as cladding 216, 218).

The core 214 (e.g., a dielectric core 214) may be a low-RF-loss core 214 as shown, for example, in FIG. 2. The core 214 can be a low RF loss tangent dielectric with low thermal conductivity. The core 214 can have uniform composition or graded composition. For example, the core 214, or a portion thereof, can be porous.

The core 214 near the mechanical support structure 106 can be configured to be capable of withstanding high temperatures with low RF loss. The core 214 can, for example, include boron nitride, hafnium oxide, hafnium silicate, zirconium oxide, aluminum oxide, celsian (i.e., barium aluminosilicate), and/or other suitable materials. The core 214 (and thus, the through-thickness waveguide 104) can, for example, have a circular, rectangular, square, or elliptical cross-section. The sides of the core 214 can, for example, be smooth (e.g., a roughness of less than about 10% of electrical skin depth, where skin depth is the depth at which the current density of an electromagnetic signal attenuates to 1/e, or approximately a third, of its value at the surface). For example, the core 214 should have smooth sides to ensure efficient transmission of radio frequency (RF) signals. Smooth surfaces reduce scattering and reflection of RF signals, which can otherwise lead to signal loss. The roughness of the core's surface should be less than 10% of the electrical skin depth. The skin depth is the distance into a conductor where the current density decreases to about 37% (or 1/e) of its value at the surface. This is important because RF currents tend to flow near the surface of conductors. The skin depth depends on the frequency of the RF signal and the material's properties. A rough surface with irregularities greater than 10% of the skin depth can cause increased resistance and signal loss. Smooth sides with reduced or minimal roughness ensures efficient transmission of RF signals by reducing scattering and reflection, which reduces or minimizes signal loss and distortion.

The core 214 of each FIG. 1 through-thickness waveguide 104 can be clad with the FIG. 2 electrically conductive layer 216, which layer 216 can be relatively thin with respect to the core 214 itself. The electrically conductive layer 216 can be highly electrically conductive (e.g., more conductive than the conductivity of the dielectric core 214), and a thickness of the electrically conductive layer 216 can be greater (e.g., although not much greater) than the skin depth of the RF radiation to minimize or reduce RF loss and also to minimize or reduce thermal conduction. For example, the thickness of the electrically conductive layer 216 for RF applications can be on the order of more than about 5 times a skin depth for conductive materials, or lesser or greater. In one or more embodiments, the skin depth may be, for example, on the order of about a few microns, or lesser or greater. The electrically conductive layer 216 can be, for example, tungsten (W), molybdenum (Mo), tantalum (Ta), niobium (Nb), rhodium (Rh), platinum (Pt), and/or certain diborides (e.g., zirconium diboride (ZrB₂)), carbides, and/or nitrides that are electrically conductive at elevated temperature, and/or other suitable materials.

The cladding 216, 218 may include the electrically conductive layer 216 and/or the diffusion barrier 218 and can be a single layer or multiple layers. In one or more embodiments, the cladding may include layers in addition to the electrically conductive layer 216 and/or the diffusion barrier 218.

In FIG. 2, the diffusion barrier 218 may be an outer layer 218 of the cladding 216, 218 (i.e., may be on a surface of the electrically conductive layer 216 closer to the mechanical support structure 106) and can be configured to prevent diffusion and/or reaction of the mechanical support structure 106 with other layers of the electrically conductive layer 216 or with the core 214. For example, in one or more embodiments, the diffusion barrier 218 may include a tantalum/tantalum carbide (Ta/TaC) layer, the mechanical support structure 106 may include or be a carbon/carbon (C/C) mechanical structure, and the electrically conductive layer 216 may include tungsten (W). In such embodiments, the diffusion barrier 218 may prevent or reduce (e.g., may be configured to prevent or reduce) the likelihood of carbon (C) in the mechanical support structure (e.g., the C/C mechanical structure) 106 from reacting with the tungsten (W) in the electrically conductive layer (e.g., inner cladding layer) 216, thus preventing the formation of tungsten carbide (WC). Such a diffusion/reaction prevention layer 218 can be designed and configured to entirely prevent reaction or diffusion, or to keep any reaction or diffusion far away from one skin depth from the dielectric-conductive layer interface (i.e., the interface between the dielectric core 214 and the electrically conductive layer 216).

The cladding 216, 218 can include a change in composition (e.g., may have a composition gradient) in a direction from the waveguide hot side to the waveguide cold side. For example, the cladding 216, 218 (e.g., the electrically conductive layer 216) can be a high temperature capable material (e.g., tungsten (W)) near the hot side, and transition to more electrically conductive but lower temperature capable material (e.g., copper (Cu)) near the cold side. Other surface patterns or layers can be added to enhance adhesion between the through-thickness waveguides 104 and the mechanical support layer 106. Those skilled in the art will appreciate that any of a variety of materials can be selected in accordance with the teachings of the present disclosure.

The radio-frequency surface-aperture system 100 according to one or more embodiments may include a cold-side mode coupler 202 as shown in FIG. 2, arranged to connect a designated cold side of the one or more through-thickness waveguides 104 to an electronic subsystem 204, such as a radar or seeker device (e.g., to the output of a radar or seeker device). The cold side mode coupler 202 can be a mode converter built onto a printed circuit board (PCB) with seeker electronics on the board. It can, for example, use standard microstrip-to-waveguide or stripline-to-waveguide techniques. Examples of microstrip-to-waveguide transitions are available in the field. Examples of these structures are described in the documents Igarashi, Sadao, “Waveguide-microstrip line converter” U.S. Pat. No. 4,725,793, 16 Feb. 1988; Murphy, Earl R. “Microstrip to waveguide transition.” U.S. Pat. No. 4,453,142, 5 Jun. 1984; and Sedivec, Darrel F. “Transition from stripline to waveguide” U.S. Pat. No. 4,562,416, 31 Dec. 1985, all of these documents being incorporated herein by reference in their entireties.

Thus, the radio-frequency surface-aperture system 100 according to one or more embodiments may include one or more surface-wave waveguides 102 on a surface of the mechanical support structure 106 in operative communication with the through-thickness waveguides 104. The surface-wave waveguides 102 can also act an antenna, and each surface-wave waveguide 102 can be connected to one or more through-thickness waveguides 104. Each surface-wave waveguide 102 can be connected either directly or indirectly to the mechanical support structure 106.

Alternately, or in addition, each surface-wave waveguide 102 can be intimately bonded to and/or fabricated on a mechanical support plane of the mechanical support structure 106. One or more surface-wave waveguides 102 can also be connected to each other in alternate embodiments as those skilled in the art will appreciate.

As illustrated in FIG. 2, each surface-wave waveguide 102 can include a dielectric layer 208, an electrically conductive layer 210, and a diffusion barrier 212 (the electrically conductive layer 210 and the diffusion barrier 212 are collectively referred to as cladding 210, 212).

The dielectric layer 208 may be on an external face of the RF surface aperture system 100 (e.g., on a surface of the surface-wave waveguide 102 away from or furthest from the mechanical support structure 106 of the layers of the surface-wave waveguide 102, with the electrically conductive layer 210 and the diffusion barrier 212 therebetween). The dielectric layer 208 can be a low RF loss tangent dielectric capable of withstanding high temperatures with low RF loss and withstanding highly oxidizing environments with minimal erosion or chemical reaction. The dielectric layer 208 can, for example, include boron nitride, hafnium oxide, hafnium silicate, zirconium oxide, aluminum oxide, celsian, and/or other suitable materials.

In one or more embodiments, the top of the dielectric layer 208 can be smooth and non-wavy. The bottom of the dielectric layer 208 can have periodic undulations or notches. Thus, the dielectric thickness can be modified with a fixed periodicity P in order to excite radiation similar to a grating or hologram. The highly conductive layer 210, which may be, for example, a highly conductive layer (cladding) relative to conductivity of the dielectric layer 208, can be configured to follow this periodicity. The mechanical support plane 106 can also follow this periodicity, at least on its designated hot side.

An RF mode can be confined to a center region of each surface-wave waveguide 102 where the dielectric layer 208 is thicker. This can be seen, for example, in FIG. 1, where the center region of the dielectric layer 208 includes the periodic undulations and has a greater thickness than the sides of the dielectric layer 208 between the periodic undulations, which may have a decreased thickness with respect to the center region due to the mechanical support plane 106. Thus, the sides of the dielectric layer 208 may be thinner, and this configuration can confine a wave between them and at the periodic undulations. For example, the RF mode (the electromagnetic wave) is confined to the center region of the surface-wave waveguide 102 where the dielectric layer 208 is thicker. The wave may be more concentrated in this thicker region. The dielectric layer 208 has periodic undulations or notches, which refers to that it has a repeating pattern of thicker and thinner sections. This pattern helps to confine the RF mode to the thicker sections. In FIG. 1, the center region of the dielectric layer 208 is thicker due to these periodic undulations. This greater thickness helps to keep the RF mode concentrated in the center region. The sides of the dielectric layer 208, between the periodic undulations, are thinner. This difference in thickness helps to confine the RF mode to the thicker center region and the periodic undulations. The configuration of having thicker regions in the center and thinner regions on the sides helps to confine the RF wave within the surface-wave waveguide 102. The wave is effectively trapped in the thicker regions and at the periodic undulations, reducing the likelihood of it spreading out and losing energy. Thus, the design of the dielectric layer 208 with its periodic undulations and varying thickness helps to efficiently confine the RF mode within the surface-wave waveguide 102, ensuring better performance and reduced signal loss. While FIG. 1 shows the surface-wave waveguides 102 each including ten periodic undulations, the present disclosure is not limited thereto and the number of periodic undulations may be varied as desired and/or as is suitable to the specific application.

Each surface wave waveguide 102 can include the electrically conductive layer 210 (e.g., more conductive and/or highly conductive relative to dielectric layer 208) that serves as an electrical ground. The conductive layer 210 can clad the bottom of the dielectric layer 208. The thickness of the highly conductive layer 210 can be greater (e.g., not much greater) than the skin depth of the RF radiation to minimize RF loss and also minimize thermal conduction. For example, the thickness of the highly conductive layer 210 for RF applications can be, as already noted, on the order of five times the skin depth of RF radiation, or lesser or greater. In one or more embodiments, the skin depth may be, for example, on the order of about a few microns, or lesser or greater. The highly conductive layer 210 can be e.g., W, Mo, Ta, Nb, Rh, Pt, and/or certain diborides (e.g., ZrB₂), carbides, and/or nitrides that are electrically conductive at elevated temperatures, and/or other suitable materials.

The cladding 210, 212 may include the electrically conductive layer 210 and/or the diffusion barrier 212 and can include one layer or multiple layers. In one or more embodiments, the cladding may include layers in addition to the electrically conductive layer 210 and/or the diffusion barrier 212.

The diffusion barrier 212 may be an inner layer of the cladding 210, 212 (i.e., on a surface of the electrically conductive layer 210 closer to the mechanical support structure 106) and can be configured to prevent diffusion and/or reaction of the mechanical support structure 106 with other layers of the cladding 210, 212 or with the dielectric layer 208. For example, in one or more embodiments, the diffusion layer 212 may include a tantalum/tantalum carbide (Ta/TaC) layer, the mechanical support structure 106 may include a carbon/carbon (C/C) structure, and the electrically conductive layer 210 may include tungsten (W). In such embodiments, the diffusion layer 212 may prevent or reduce the likelihood of carbon (C) in the mechanical support structure 106 from reacting with the tungsten in the electrically conductive layer (e.g., the outer cladding layer) 210, thus preventing the formation of tungsten carbide (WC). Such a diffusion/reaction prevention layer can be configured to entirely prevent reaction or diffusion or to keep any reaction or diffusion far away from one skin depth from the dielectric-conductive layer interface (i.e., the interface between the dielectric layer 208 and the electrically conductive layer 210). Other surface patterns or layers can be added to enhance adhesion between the surface-wave waveguide 102 and the mechanical support structure 106.

Each surface-wave waveguide 102 can have a high emissivity for radiative cooling in the visible and infrared regions of the electromagnetic (EM) spectrum. A surface coating (e.g., the high emissivity coating 206) can be added to improve emissivity in the visible spectrum and/or infrared spectrum.

In one or more embodiments, the high temperature radio frequency surface-aperture system 100 can also include a material or system to remove or store heat that conducts through to the cold side. For example, a thermal phase change material (e.g., a wax, an inorganic salt hydrate) can be included, and/or a composite of a thermal phase change material and a highly thermally conductive phase (e.g., graphite) can be included. In one or more embodiments, a vapor-compression refrigeration system, an air-cooled system (e.g., cooling fan), and/or a liquid cooled system may be provided to cool the system 100.

In one or more embodiments, the high temperature radio frequency surface-aperture system 100 can also include a surface-wave launcher 220, as shown in FIG. 2. The surface-wave launcher 220 may include a waveguide opening configured to improve transmission or provide maximal transmission from the through-thickness waveguide 104 to the surface-wave waveguide 102 at frequencies of interest.

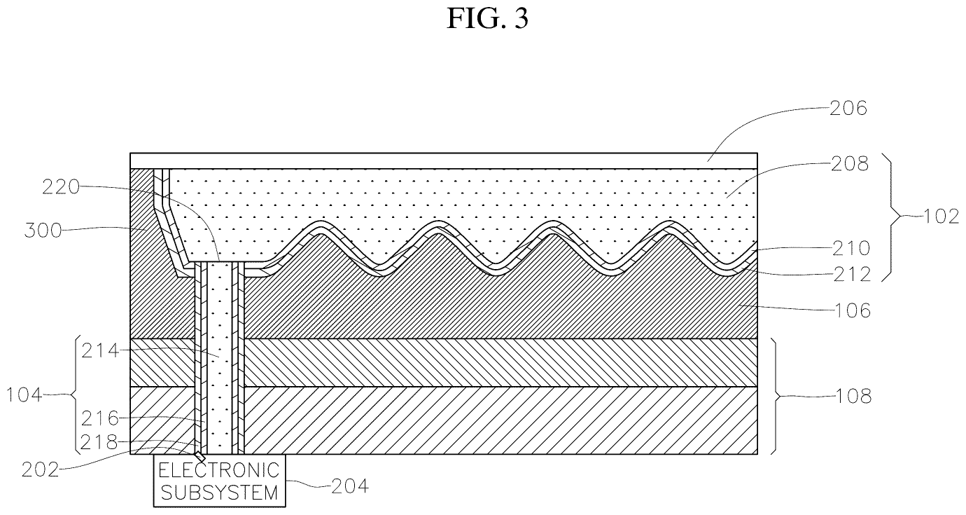

As shown in FIG. 3, according to one or more embodiments, the waveguide opening of the surface-wave launcher 220 can be located approximately λ/4 from a reflective wall 300 of the radio frequency surface-aperture system 100 to launch a surface wave away from the reflective wall 300. The reflective wall 300 may be bound to the grounded dielectric (e.g., the reflective wall 300 may include the electrically conductive layer 210 to ground the dielectric layer 208). The reflective wall 300 may include the mechanical support structure 106, the electrically conductive layer 210, and the diffusion barrier 212, which are described in more detail above. The electrically conductive layer 210 may provide the reflective surface of the reflective wall 300 and may reflect RF signals that contact the reflective wall 300. For example, the electrically conductive layer 210 may include e.g., W, Mo, Ta, Nb, Rh, Pt, and/or certain diborides (e.g., ZrB₂), carbides, and/or nitrides that can provide a reflective surface. The λ/4 spacing can be used to minimize or reduce reflection from the reflective wall 300 back into the through-thickness waveguide 104 and to enhance propagation into the surface-wave waveguides 102. Thus, the reflective wall 300 can reflect RF signals from through-thickness waveguides 104 away from the through-thickness waveguides 104 so that the signals are effectively sent from the aperture system 100.

The reflective wall 300 can be identified in FIG. 3 as the wall near and/or closest to the surface-wave launcher 220. The grounded dielectric refers to the electrically conductive layer 210, which acts as a ground for the dielectric layer 208. The term “into the surface-wave waveguides” may refer to that the RF energy is efficiently transmitted into and through the surface-wave waveguides 102.

In one or more embodiments, the waveguide opening of the surface-wave launcher 220 can have the same size and shape as the through-thickness waveguide 104, or it can have a different size and/or shape. For example, the waveguide opening can have the shape of a slot, a rectangular aperture, a polygonal aperture, a circular aperture, or an irregular polygon aperture. The aperture geometry can be tuned to allow maximal transmission from the though-thickness waveguide 102 to the surface-wave waveguide 102 at frequencies of interest for the seeker.

In one or more embodiments the aperture system 100 can include two or more through-thickness waveguides 104 that are phase tuned to launch a surface wave into corresponding surface-wave waveguides 102 with minimal reflection. This phase tuning can be applied by the electronic subsystem 204 (e.g., by seeker electronics i.e. utilizing phase shifters), or it can be based on the geometry of the through-thickness waveguides 104. In one or more embodiments, the through-thickness waveguides 104 may all have the same structure. However, waveguides can also be made of different materials or can be made to have different geometries, if desired, as those skilled in the art will appreciate.

Additional inductive or capacitive inclusions near the waveguide opening can also be added to improve coupling between a through-thickness waveguide mode and a surface wave waveguide mode. These inclusions can, for example, include metal-insulator-metal capacitive layers, or coiled metal inductance components. In one or more embodiments, the inclusions can be high temperature dielectrics or metals as already described, but do not need to match the materials of the conductive ground (e.g., the electrically conductive layers 210 and/or 216) or surface-wave waveguides 102.

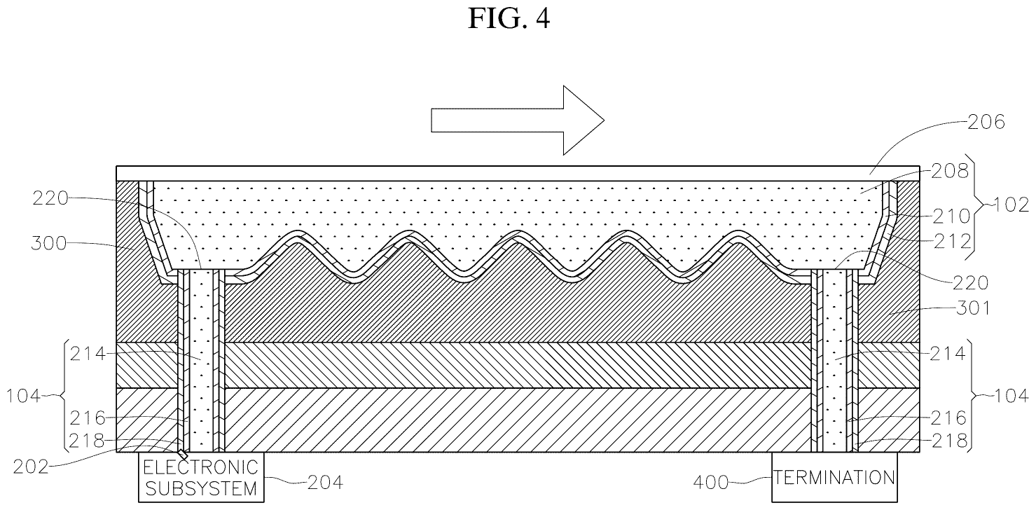

In one or more embodiments, a termination 400, as shown in FIG. 4, can be included on the side of (e.g., on the side of each) surface-wave waveguide 102 away from or farthest from the connection with the corresponding through-thickness waveguide 104 in order to terminate the surface-wave waveguide 102. Such a feature can be included so that RF energy does not scatter off the far wall 301 of the surface-wave waveguide 102 or bounce off the far wall 301 and head the other direction in the surface-wave waveguide 102. In one or more embodiments, the termination 400 may include a mirror image mode-launcher that can reflect a mirror image of the RF signal wave in a direction opposite to the incoming RF signal, thus causing destructive interference and preventing the RF signal from continuing to propagate back in the direction it originated. The mirror image mode-launcher acts as a termination at the far wall 301 (e.g., the wall farthest from the through-thickness waveguide 104) to prevent RF signal waves or to reduce the number of RF signal waves bouncing back towards the through-thickness waveguides 104. In one or more embodiments, the termination can include RF absorbing material to absorb RF signals and prevent the RF signals from returning towards the direction from which they originated. In one or more embodiments, the termination 400 may be a passive resistor and/or attenuator. For example, the termination 400 may be a resistor set to the characteristic impedance of the waveguide mode to effectively terminate the RF signal waves at the far wall 301. Thus, the termination 400 can help maintain the wave propagation of the RF signals in the desired direction (i.e., right-to-left as shown by the arrow in FIG. 4).

As shown in FIG. 4, the termination 400 may be at the bottom of a second through thickness waveguide 104 located at the far wall 301. The second through-thickness waveguide may direct and deliver a propagating wave to the termination 400 to facilitate the termination of the wave and reduce the likelihood of the wave propagating back through the surface-wave waveguide 102 and to the original through-thickness waveguide 104 at the reflective wall 300. The second through-thickness waveguide 104 may include the same features as described above with respect to the through-thickness waveguides 104, including, for example, the cladding 210, 212 on a surface thereof, thus redundant description may not be provided.

A method of manufacturing a radio frequency surface-aperture system, as disclosed herein can include: providing (supplying) a mechanical support structure selected for maintaining mechanical stiffness and strength at a selected temperature equal to or greater than 1200° C.; applying a thermal insulation having at least a single layer to the mechanical support structure; establishing one or more through-thickness waveguides through a thickness of the mechanical support structure and the thermal insulation; arranging a cold-side mode coupler in operative contact with the mechanical support structure and thermal insulation to connect a designated cold side of the one or more through-thickness waveguides to a radar or seeker device; and providing (applying) one or more surface-wave waveguides on a surface of the mechanical support structure in operative communication with the through-thickness waveguides.

In one or more embodiments, a method of manufacturing a radio frequency surface-aperture system, as disclosed herein, can include providing a mechanical support structure selected for maintaining mechanical stiffness and strength at a selected temperature equal to or greater than 1200° C. This structure can be made from materials such as metals (e.g., Inconel, Haynes, Ni superalloy), refractory metals (e.g., tungsten, molybdenum), and/or ceramic matrix composites (e.g., carbon/carbon composites). Next, a thermal insulation having at least a single layer is applied to the mechanical support structure. The insulation can be made from materials like porous graphite, alumina, aluminosilicate, silica, and/or boron nitride, which helps to protect the underlying structure from high temperatures. One or more through-thickness waveguides are then established through the thickness of the mechanical support structure and the thermal insulation. These waveguides are designed to provide a low-loss RF path from the hot side to the cold side of the structure and can include a dielectric core, an electrically conductive layer, and a diffusion barrier to prevent unwanted reactions.

Following this, a cold-side mode coupler is arranged in operative contact with the mechanical support structure and thermal insulation to connect a designated cold side of the through-thickness waveguides to a radar or seeker device. The mode coupler ensures efficient transmission of RF signals from the waveguides to the electronic subsystem. One or more surface-wave waveguides are then provided on the surface of the mechanical support structure in operative communication with the through-thickness waveguides. These surface-wave waveguides act as antennas for transmitting and receiving RF signals and can include a dielectric layer, an electrically conductive layer, and a diffusion barrier. A high emissivity coating is applied to the surface-wave waveguides to improve radiative cooling in the visible and infrared regions of the electromagnetic spectrum, helping to manage the thermal load on the system.

Additionally, materials or systems to remove or store heat that conducts through to the cold side are incorporated. This can involve using thermal phase change materials, vapor-compression refrigeration systems, air-cooled systems, and/or liquid-cooled systems to maintain optimal operating temperatures. A surface-wave launcher is configured with a waveguide opening to improve transmission from the through-thickness waveguide to the surface-wave waveguide. The waveguide opening can be tuned to specific frequencies of interest and positioned to minimize reflections and maximize efficiency. Phase tuning of the through-thickness waveguides is also performed to launch surface waves with minimal reflection, achieved through electronic phase shifters or by adjusting the geometry of the waveguides. Additional inductive and/or capacitive inclusions can be added near the waveguide opening to improve coupling between the waveguide modes.

The subsystem 204 (e.g., radar, or radar/seeker) can be configured in any known manner to receive electromagnetic energy (e.g., RF energy) and perform any desired seeking and/or radar function or other function. The subsystem can, for example, include a computer processor and execute a software program stored on a non-transitory computer-readable medium. The medium can be configured to store program code for performing data processing. A person having ordinary skill in the art will appreciate that embodiments of the disclosed subject matter can be practiced with one or more modules in a hardware processor device with an associated memory. A hardware processor device as discussed herein can be a single hardware processor, a plurality of hardware processors, or combinations thereof.

In an example embodiment, control signals, processing algorithms, artificial intelligence capabilities, and so forth can be provided to or from the electronic subsystem using any suitable local or remote database configuration. Suitable configurations and storage types will be apparent to persons having skill in the relevant art.

The example computing device of the electronic subsystem can include a communications interface. The communications interface can be configured to allow software, control signals and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Further, the use of “may” when describing embodiments of the present disclosure refers to “one or more embodiments of the present invention.”

It will be appreciated by those skilled in the art that the present disclosure can be embodied in other specific forms without departing from the spirit or essential characteristics thereof. The presently disclosed embodiments are therefore considered in all respects to be illustrative and are not restrictive. The scope of the present disclosure is indicated by the appended claims and equivalents thereof rather than the foregoing description and all changes that come within the meaning and range and equivalence thereof are intended to be embraced therein.

What is claimed is:

1. A radio frequency surface-aperture system comprising:
a mechanical support structure for maintaining mechanical stiffness and strength at a selected temperature;
thermal insulation having at least a single layer;
one or more through-thickness waveguides located through a thickness of the mechanical support structure and thermal insulation;
a cold-side mode coupler arranged to connect a designated cold side of the one or more through-thickness waveguides to an electronic subsystem; and
one or more surface-wave waveguides arranged as a radio frequency (RF) antenna on a surface of the mechanical support structure in operative communication with the through-thickness waveguides.

2. A radio frequency surface-aperture system according to claim 1, wherein the mechanical support structure is a plate which is at least one of RF-loss, and/or is RF-opaque.

3. A radio frequency surface-aperture system according to claim 1, wherein the mechanical support structure is configured for operation at temperatures up to and above 1200° C.

4. A radio frequency surface-aperture system according to claim 1, wherein the mechanical support structure has a designated hot side and a designated cold side, wherein the hot side is configured for exposure to temperatures which will exceed those of the cold side.

5. A radio frequency surface-aperture system according to claim 1, wherein the thermal insulation has a designated hot side and a designated cold side, wherein the hot side is configured for exposure to temperatures which will exceed those of the cold side.

6. A radio frequency surface-aperture system according to claim 1, wherein each through-thickness waveguide of the one or more through-thickness waveguides has a core configured to reduce RF loss, and wherein the core is a low RF loss tangent dielectric with low thermal conductivity.

7. A radio frequency surface-aperture system according to claim 6, wherein the core is clad with a cladding comprising a thin, electrically conductive layer, with a thickness of the electrically conductive layer being selected to be greater than a skin depth of a selected RF radiation to minimize RF loss and thermal conduction, the cladding having one or more layers.

8. A radio frequency surface-aperture system according to claim 7, wherein each of the one or more through-thickness waveguides has a diffusion barrier as an outer layer of the cladding, the diffusion barrier to prevent diffusion and/or reaction of the mechanical support structure with other layers of the cladding or with the core, the diffusion barrier comprising a Ta/TaC layer to prevent diffusion of carbon (C) from a C/C mechanical support structure and for preventing formation of tungsten carbide (WC).

9. A radio frequency surface-aperture system according to claim 8, wherein the cladding has a composition that changes from a through-thickness waveguide hot side to a through-thickness waveguide cold side.

10. A radio frequency surface-aperture system according to claim 1, wherein the one or more through-thickness waveguides are each configured to provide an RF path from a designated hot side of the mechanical support structure to a designated cold side of the thermal insulation.

11. A radio frequency surface-aperture system according to claim 1, wherein the cold-side mode coupler is a mode converter located on a printed circuit board (PCB), in combination with electronics located on the PCB board.

12. A radio frequency surface-aperture system according to claim 1, wherein each surface-wave waveguide of the one or more surface-wave waveguides includes a dielectric layer on an external face of the radio frequency surface-aperture, wherein a top of the dielectric layer is smooth, and a bottom of the dielectric layer has periodic undulations or notches.

13. A radio frequency surface-aperture system according to claim 12, wherein each surface-wave waveguide of the one or more surface-wave waveguides comprises a conductive layer as an electrical ground and a diffusion barrier,
wherein the conductive layer clads a bottom of the dielectric layer; and
wherein the diffusion barrier is closer to the mechanical support structure than the conductive layer is to the mechanical support structure and is to prevent diffusion and/or reaction of the mechanical support structure with the conductive layer.

14. A radio frequency surface-aperture system according to claim 1, in combination with a radar or seeker connected to the cold-side mode coupler.

15. A radio frequency surface-aperture system according to claim 1, comprising:
a mirror image mode-launcher on a side of the one or more surface-wave waveguides farthest from the through-thickness waveguides to terminate the one or more surface-wave waveguides.

16. A radio frequency surface-aperture system according to claim 1, comprising:
a system to remove or store heat that conducts through to the cold-side mode coupler when in operation.

17. A radio frequency surface-aperture system according to claim 1, wherein at least one of the one or more through-thickness waveguides comprises a waveguide opening located approximately λ/4 from an external wall of the radio frequency surface-aperture.

18. A radio frequency surface-aperture system as claimed in claim 17,
wherein the waveguide opening has the same size and shape as a cross-section of at least one of the one or more through-thickness waveguides; and
wherein the one or more through-thickness waveguides comprises two or more through-thickness waveguides that are phase tuned to launch a surface wave into at least one of the one or more surface-wave waveguides with reduced reflection.

19. A radio frequency surface-aperture system as claimed in claim 17, further comprising:
inductive or capacitive inclusions near the waveguide opening for coupling between a waveguide mode and a surface-wave waveguide mode.

20. A method of manufacturing a radio frequency surface-aperture system, the method comprising:
supplying a mechanical support structure for maintaining mechanical stiffness and strength at a selected temperature up to or greater than 1200° C.;
applying a thermal insulation having at least a single layer to the mechanical support structure;
establishing one or more through-thickness waveguides through a thickness of the mechanical support structure and the thermal insulation;
arranging a cold-side mode coupler in operative contact with the mechanical support structure and thermal insulation to connect a designated cold side of the one or more through-thickness waveguides to an electronic subsystem; and
applying one or more surface-wave waveguides arranged as radio frequency (RF) antenna on a surface of the mechanical support structure in operative communication with the one or more through-thickness waveguides.
